(19) United States
(12) Patent Application Publication
(10) Pub. No.: US 2011/0109926 A1
(43) Pub. Date: May 12, 2011

(54) COMMODITY SALES DATA PROCESSING APPARATUS AND CONTROL METHOD THEREFOR

(75) Inventor: Hirokazu Asaga, Shizuoka (JP)

(73) Assignee: TOSHIBA TEC KABUSHIKI KAISHA, Tokyo (JP)

(21) Appl. No.: 12/942,168

(22) Filed: Nov. 9, 2010

(30) Foreign Application Priority Data
Nov. 12, 2009 (JP) 2009-259202

(51) Int. Cl. G06F 15/00

(52) U.S. Cl. 358/1.9

(57) ABSTRACT

According to one embodiment, a commodity sales data processing apparatus includes a printing unit, an input unit, a printing-data creating unit, a correcting unit, and a printing control unit. The printing unit prints a receipt. The input unit receives input of information concerning a commodity. The printing-data creating unit creates, on the basis of information concerning commodities input via the input unit, printing data for causing the printing unit to print a receipt including detail information of a transaction. The correcting unit corrects the printing data such that the length of the receipt printed by the printing unit on the basis of the printing data is reduced. The printing control unit causes the printing unit to print a receipt based on one of the printing data created by the printing-data creating unit and the printing data corrected by the correcting unit.

### CROSS-REFERENCE TO RELATED APPLICATIONS

This application is based upon and claims the benefit of priority from Japanese Patent Application No. 2009-259202, filed on Nov. 12, 2009, the entire contents of which are incorporated herein by reference.

### FIELD

Embodiments described herein relate generally to a commodity sales data processing apparatus and a control method therefor used in checkout processing for a transaction in a commodity selling store or a service providing store.

### BACKGROUND

In a retail store, an eating house, or the like, a commodity sales data processing apparatus such as a POS (Point Of Sales) terminal or an ECR (Electric Cash Register) is used for checkout for a transaction. This apparatus receives input of information concerning commodities or the like related to a transaction via reading of a barcode by a scanner or operation of a keyboard or a touch panel and registers the input information in a predetermined storing unit. When closing of the transaction is declared, the apparatus calculates a price on the basis of the information registered in the storing unit and receives payment of the price by cash, a debit card, a credit card, or electronic money. Usually, a printer that prints detail information of a transaction and store information on a printing medium such as thermal recording paper is connected to or incorporated in the commodity sales data processing apparatus. When a commercial transaction is concluded, a receipt for a customer and a journal for a store are printed and issued from the printer.

In recent years, from the viewpoint of ecology and a reduction in cost required for consumables, there is an increasing demand for saving of printing media used in the printer. To cope with such a situation, inventions for the saving of the printing media are also made.

As an example, a printer is known that reduces the size of a character string printed on a journal to enable the saving of the printing media. However, concerning a receipt handed to a customer, since it is necessary to secure satisfactory visibility to some extent, the reduction in the size of a character string is not performed.

However, a long receipt is too bulky when stored in a purse and it is troublesome to thereafter keep the long receipt. Therefore, under the present situation, there are many customers who desire a short receipt from the viewpoint of easiness of handling.

From such circumstances, it is necessary to take measures for realizing saving of printing media for receipts, a reduction in cost for store management, and saving of resources while accurately reflecting demands of a store and customers.

### BRIEF DESCRIPTION OF THE DRAWINGS

FIG. 1 is an external perspective view of a commodity sales data processing apparatus according to an embodiment;

FIG. 2 is a block diagram of a control circuit of the commodity sales data processing apparatus;

FIG. 3 is a diagram of data structure of a commodity data registration area of the commodity sales data processing apparatus;

FIG. 4 is a flowchart of the operation of a CPU of the commodity sales data processing apparatus;

FIG. 5 is a diagram of printing data of a receipt in a normal mode created by the commodity sales data processing apparatus; and

FIG. 6 is a diagram of printing data of a receipt in a saving mode created by the commodity sales data processing apparatus.

### DETAILED DESCRIPTION

In general, according to one embodiment, a commodity sales data processing apparatus includes a printing unit, an input unit, a printing-data creating unit, a correcting unit, and a printing control unit. The printing unit prints a receipt. The input unit receives input of information concerning a commodity. The printing-data creating unit creates, on the basis of information concerning commodities input via the input unit in one commercial transaction, printing data for causing the printing unit to print a receipt including detail information of the transaction. The correcting unit corrects the printing data such that the length of the receipt printed by the printing unit on the basis of the printing data is reduced. The printing control unit causes the printing unit to print a receipt based on one of the printing data created by the printing-data creating unit and the printing data corrected by the correcting unit.

An embodiment is explained below with reference to the accompanying drawings.

In this embodiment, a commodity sales data processing apparatus such as a POS terminal used in an eating house is explained as an example.

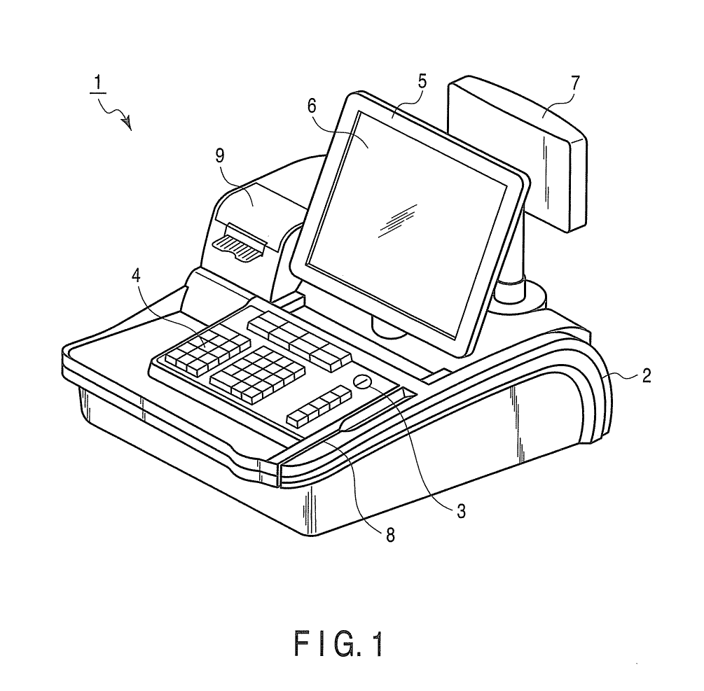

FIG. 1 is an external perspective view of a commodity sales data processing apparatus 1 according to this embodiment.

A main body 2 of the commodity sales data processing apparatus 1 includes a key switch 3, a mechanical keyboard 4, a casher side display 5 with a display surface faced to a casher side, a touch panel 6 provided on a front surface of the casher side display 5, a customer side display 7 with a display surface faced to a customer side, a card reader 8 of a slide type, and a receipt printer 9 functioning as a printing unit in this embodiment.

A key switch 3 is a rotary switch having a keyhole for receiving insertion of a dedicated operation key. The key switch 3 switches an operation mode of the commodity sales data processing apparatus 1 according to a rotation stop position.

The keyboard 4 includes a ten key for numerical value input and a printing mode selection key 34 functioning as a selection receiving unit in this embodiment. The printing mode selection key 34 is used in designating in which of a normal mode and a saving mode a receipt is printed in checkout processing explained later. The normal mode is a mode for printing a conventional receipt. The saving mode is a mode for printing a receipt shorter than the receipt printed in the normal mode and saving a receipt sheet.

The casher side display 5 is, for example, an LCD (Liquid Crystal Display). The casher side display 5 selectively displays preset keys and the like for designating commodities eaten and drunk by a customer. A casher can touch and operate the preset keys via the touch panel 6. When the preset keys are touched and operated, commodity data preset in the respective keys is input to the main body 2. In other words, the preset keys function as an input unit in this embodiment.

The customer side display 7 is, for example, a VFD (Vacuum Fluorescent Display). The customer side display 7 selectively displays names and prices of commodities input via the preset keys, a total amount of a transaction, a change amount, and the like.

The card reader 8 reads card information from a magnetic card such as a credit card or a point card slid in a slide groove.

The receipt printer 9 is, for example, a thermal printer. The receipt printer 9 conveys a receipt sheet (a printing medium) such as thermal recording paper wound in a roll shape to a contact position between a thermal head and a platen roller and controls energization to the thermal head to print a receipt including characters, figures, or a pattern formed by combining the characters and the figures.

A control circuit of the commodity sales data processing apparatus 1 is explained below.

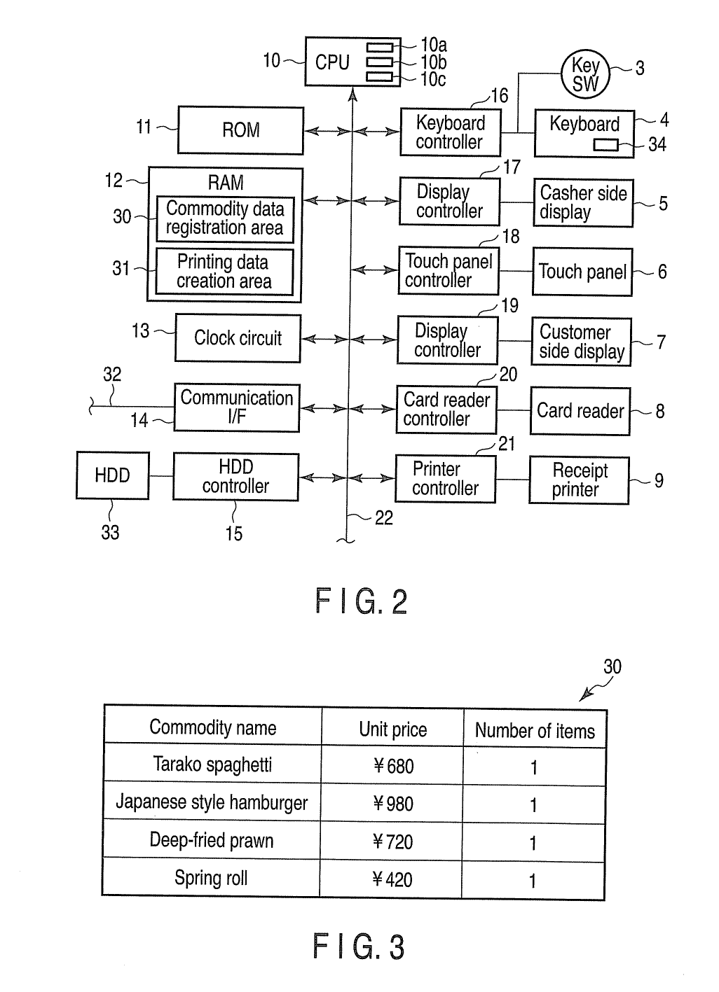

FIG. 2 is a block diagram of a control circuit of the commodity sales data processing apparatus 1.

The main body 2 of the commodity sales data processing apparatus 1 is mounted with a CPU (Central Processing Unit) 10 functioning as a center of control. A ROM (Read Only Memory) 11, a RAM (Random Access Memory) 12, a clock circuit 13, a communication I/F (Interface) 14, a HDD (Hard Disk Drive) controller 15, a keyboard controller 16, a display controller 17, a touch panel controller 18, a display controller 19, a card reader controller 20, a printer controller 21, and the like are connected to the CPU 10 via a bus line 22 such as an address bus or a data bus.

A LAN (Local Area Network) 32 is connected to the communication I/F 14, a HDD 33 is connected to the HDD controller 15, the key switch (SW) 3 and the keyboard 4 are connected to the keyboard controller 16, and the casher side display 5 is connected to the display controller 17, the touch panel 6 is connected to the touch panel controller 18, the customer side display 7 is connected to the display controller 19, the card reader 8 is connected to the card reader controller 20, and the receipt printer 9 is connected to the printer controller 21.

The ROM 11 has stored therein stationary data such as a BIOS (Basic Input/Output System).

In the RAM 12, various storage areas for work are formed according to processing scenes. In particular, during execution of checkout processing, a commodity data registration area 30 in which commodity data such as commodity names and commodity unit prices and the numbers of sold items of commodities input via the preset keys are registered and a printing data creation area 31 in which printing data of a receipt is created are formed.

An example of data structure of the commodity data registration area 30 is shown in FIG. 3. In this example, a unit price “\680” and the number of items “1” are registered for a commodity name “tarako spaghetti”, a unit price “\980” and the number of items “1” are registered for a commodity name “Japanese style hamburger”, a unit price “\720” and the number of items “1” are registered for a commodity name “deep-fried prawn”, and a unit price “\420” and the number of items “1” are registered for a commodity name “spring roll”.

The communication I/F 14 controls communication with a host apparatus such as a store server connected thereto via the LAN 32.

The HDD 33 has stored therein software and databases necessary for realizing functions of the commodity sales data processing apparatus such as an OS file and an application file. The HDD controller 15 controls writing of data in and readout of data from the HDD 33.

The keyboard controller 16 generates, on the basis of an electric signal output from the key switch 3 according to a rotation stop position or an electric signal output from the keyboard 4 according to a depressed operation key, a digital signal indicating a selected operation mode or a type of the depressed operation key and notifies the CPU 10 of the digital signal.

The display controller 17 controls screen display of the casher side display 5 according to a command from the CPU 10.

The touch panel controller 18 specifies a touch operation position on the basis of an electric signal output when the touch panel 6 is touch-operated and notifies the CPU 10 of the touch operation position.

The display controller 19 controls screen display of the customer side display 7 according to a command from the CPU 10.

The card reader controller 20 controls timing for reading a magnetic card by the card reader 8 and notifies the CPU 10 of card information read by the card reader 8.

The printer controller 21 drives the receipt printer 9 on the basis of printing data created in the printing data creation area 31 and causes the receipt printer 9 to issue a receipt including detail information of a transaction.

The CPU 10 executes an operation program stored in the ROM 11 or the HDD 33 to function as a printing-data creating unit 10a, a correcting unit 10b, and a printing control unit 10c.

The printing-data creating unit 10a creates, on the basis of information concerning commodities input via the preset keys in one commercial transaction, printing data for causing the receipt printer 9 to print a receipt including detail information of the transaction.

The correcting unit 10b corrects the printing data created by the printing-data creating unit 10a such that the length of a receipt printed by the receipt printer 9 is reduced on the basis of the printing data.

The printing control unit 10c causes the receipt printer 9 to print a receipt based on one of the printing data created by the printing-data creating unit 10a and the printing data corrected by the correcting unit 10b.

The operation of the commodity sales data processing apparatus 1 during checkout is explained below.

When a customer finishing eating and drinking in a store proceeds to a register, the casher operates the keyboard 4 and declares the start of checkout processing. According to the declaration, the CPU 10 executes an operation program for the checkout processing.

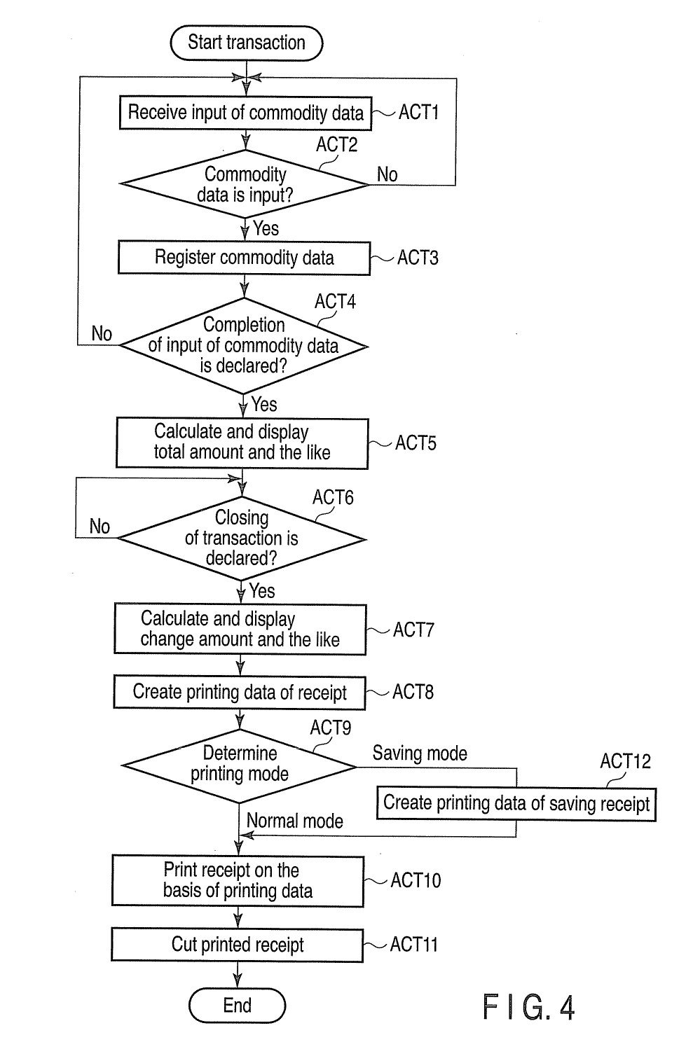

FIG. 4 is a flowchart of the operation of the CPU 10 in a series of checkout processing.

First, the CPU 10 waits for input of commodity data via the preset keys displayed on the casher side display 5 (ACT 1 and No in ACT 2). At this point, the casher finds out a preset key indicating a commodity eaten or drunk by the customer and touch-operates a display position of the relevant preset key with a fingertip or a touch pen. When the display position of the preset key is touch-operated, as explained above, the touch panel controller 18 notifies the CPU 10 of the touch operation position. The CPU 10 determines that commodity data is input (Yes in ACT 2) and registers commodity data corresponding to the preset key displayed in the touch operation position in the commodity data registration area 30. If a numerical value is input via the ten key provided in the keyboard 4 simultaneously with the operation of the preset key, the CPU 10 updates the number of sold items of the commodity data registered in the commodity data registration area 30 with the input numerical value. When a numerical value is not input simultaneously with the operation of the preset key, the CPU 10 sets the number of sold items of the commodity to “1”.

After the commodity data is registered in the commodity data registration area 30 in this way, the CPU 10 determines whether completion of input of all commodity data related to the transaction is declared (ACT 4). This determination is performed on the basis of whether a sub-total key provided on the keyboard 4 is depressed. If the sub-total key is not depressed yet, the CPU 10 determines that the input of the commodity data is not completed (No in ACT 4) and waits for input of commodity data again (ACT 1 and No in ACT 2).

On the other hand, if the sub-total key is already depressed, the CPU 10 determines that the completion of the input of the commodity data is declared (Yes in ACT 4). The CPU 10 calculates a sub-total amount and a total amount of the transaction on the basis of the commodity data registered in the commodity data registration area 30 and causes, via the display controllers 17 and 19, the casher side display 5 and the customer side display 7 to display the calculated sub-total amount and the like (ACT 5). Thereafter, the CPU 10 waits for declaration of closing of the transaction while receiving input of a deposit amount from the customer via the keyboard 4 (No in ACT 6).

When a closing key provided on the keyboard 4 is depressed in a state in which the deposit amount is input, the CPU 10 determines that the closing of the transaction is declared (Yes in ACT 6). The CPU 10 subtracts the total amount from the input deposit amount to calculate a change amount and causes, via the display controllers 17 and 19, the casher side display 5 and the customer side display 7 to display the calculated change amount and the like (ACT 7).

Subsequently, the CPU 10 creates, on the basis of information registered in the commodity data registration area 30 in the transaction, printing data of a receipt including detail information of the transaction in the printing data creation area 31 (ACT 8).

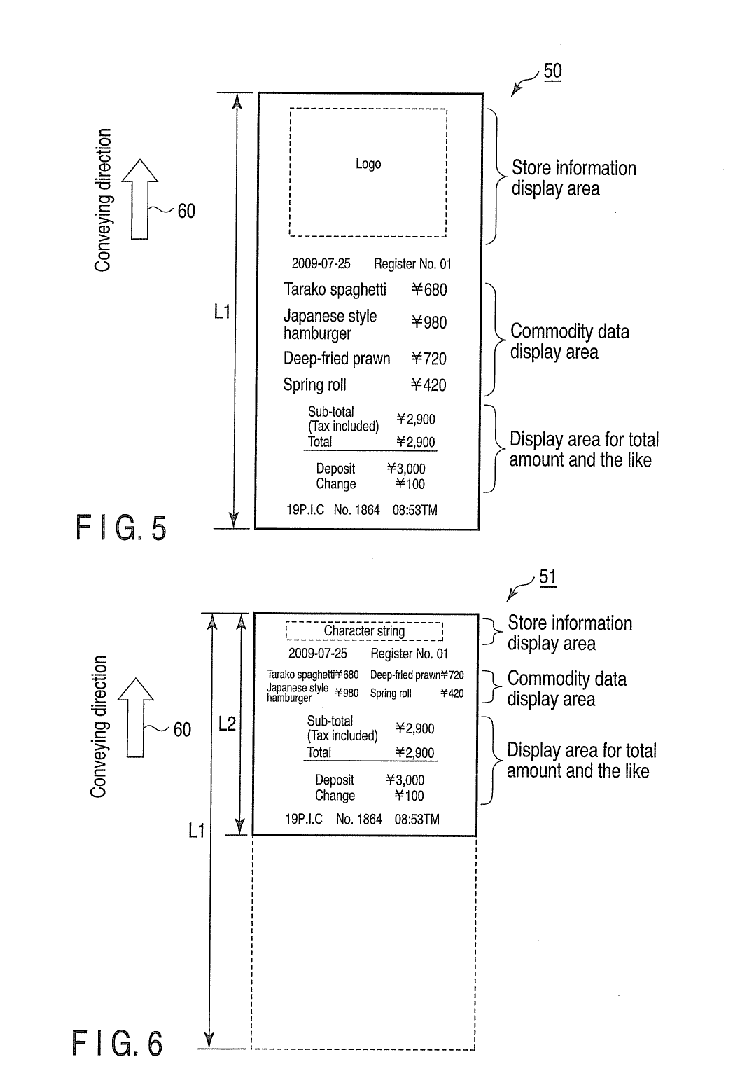

An example of printing data 50 created in the printing data creation area 31 in the operation in ACT 8 is shown in FIG. 5. The printing data 50 is displayed with the leading end of a receipt issued from the receipt printer 9 set on the upper side and the trailing end thereof set on the lower side. Therefore, a conveying direction of a receipt sheet in printing a receipt by the receipt printer 9 based on the printing data 50 is a direction indicated by an arrow 60.

The printing data 50 includes a store information display area (a first area) provided on a distal end side, a commodity data display area (a second area) provided under the store information display area, and a display area for a total amount, etc. (a third area) provided under the commodity data display area.

The store information display area is an area in which information concerning the store where checkout of a transaction is performed by the commodity sales data processing apparatus 1 is displayed. In the example shown in the figure, a logo is displayed. In the commodity data display area, commodity data registered in the commodity data registration area 30 is displayed in a font f1 to be arranged in one row along the conveying direction (i.e., in one row in the width direction of the receipt). In the display area for a total amount, etc., a sub-total amount and a total amount of a transaction, a deposit amount of a customer, a change amount, and the like are displayed in a font f2. The length in the conveying direction of the receipt used in the store information display area and the display area for a total amount, etc. among the display areas is fixed without being affected by transaction content. On the other hand, the length in the conveying direction of the receipt used in the commodity data display area is longer as the number of commodity data registered in the commodity data registration area 30 is larger. Therefore, length L1 (L1>0) of the receipt issued on the basis of the printing data created in the operation in ACT 8 increases or decreases in proportion to the number of commodity data registered in the commodity data registration area 30.

While the operations in ACT 5 and ACT 6 are executed, the casher asks the customer which of a receipt normally printed and a receipt shorter than normal the customer desires. When the customer answers that the customer desires the receipt shorter than normal, the casher depresses the printing mode selection key 34.

After finishing creating the printing data in the printing data creation area 31, the CPU 10 determines whether a printing mode is set to the normal mode or the saving mode (ACT 9). If the casher does not depress the printing mode selection key 34, the CPU 10 determines that the normal mode is selected (normal mode in ACT 9). The CPU 10 causes, via the printer controller 21, the receipt printer 9 to print a receipt based on the printing data created in the printing data creation area 31 in the operation in ACT 8 (ACT 10). When the receipt printer 9 finishes printing the receipt, the CPU 10 causes a not-shown cutter mechanism to operate and separates a receipt printed portion from a receipt sheet as continuous paper (ACT 11) and ends a series of checkout processing. The receipt issued in this way is handed from the casher to the customer.

On the other hand, if the printing mode selection key 34 is depressed, the CPU 10 determines that the saving mode is selected (saving mode in ACT 9). In this case, the CPU 10 corrects the printing data created in the printing data creation area 31 and creates printing data of a saving receipt (ACT 12).

An example of printing data 51 of the saving receipt created at this point is shown in FIG. 6. This printing data 51 is an example obtained by correcting the printing data 50 shown in FIG. 5. The logo of the store in the store information display area is deleted and replaced with a store name displayed as a character string in one row. In addition, the font of the commodity data displayed in the commodity data display area is reduced to f3 (f3<f1) and the commodity data is arranged in two rows along the conveying direction. However, since information displayed in the display area for a total amount, etc. is important in recognizing a final transaction amount, the font and the arrangement are not changed.

By correcting the printing data 50 in this way, printing data having receipt length L2 shorter than the receipt length L1 before the correction (L1>L2>0) is created. The printing data 51 after the correction is stored overwriting the printing data 50 created in the printing data creation area 31. Therefore, in the operation in ACT 10, a receipt based on the printing data after the correction is printed by the receipt printer 9.

As explained above, the commodity sales data processing apparatus 1 in this embodiment creates printing data of a receipt including detail information of a transaction on the basis of the commodity data registered in the commodity data registration area 30, corrects the printing data when a customer desires a short receipt, and issues a receipt with length in the conveying direction reduced. Consequently, a customer who desires a normal receipt can receive a conventional receipt and a customer who desires a short receipt can receive the short receipt that is, for example, easily stored in a purse. Further, since it is possible to save the receipt sheet by the selection of the saving receipt, it is possible to realize a reduction in cost of store management and saving of resources.

Specifically, the logo of the store is replaced with the store name displayed as a character string in one row, the font of the commodity data is reduced, and the commodity data after the reduction is arranged in two rows along the conveying direction of the receipt sheet to reduce the receipt length. Since the logo of the store is often unnecessary for customers, no particular problem occurs even if the logo is deleted. It seems that the customer who desires the short sheet often cares about a total amount rather than respective commodity data. Therefore, even if the sheet length is corrected to be short, a role of the receipt is not substantially spoiled.

The configuration disclosed in the embodiment can be embodied by being modified as appropriate.

For example, in the embodiment, the commodity sales data processing apparatus 1 used in an eating house is explained as an example. However, it goes without saying that the same configuration may be applied to commodity sales data processing apparatuses used in stores that provide other kinds of services and commodity sales data processing apparatuses used in a retail store and the like. If the input unit for commodity data is changed to, for example, scanning of a barcode by a scanner or information to be printed on a receipt is added according to a type of commodity sales data to which the configuration is applied, effects same as the effects realized by the commodity sales data processing apparatus 1 disclosed in the embodiment can be obtained.

In the explanation in the embodiment, the commodity sales data processing apparatus 1 causes the casher to operate the printing mode selection key 34 to switch the normal mode and the saving mode. However, an operation key equivalent to the printing mode selection key 34 may be provided on a customer surface side of the commodity sales data processing apparatus 1 to cause the customer to switch the normal mode and the saving mode. Consequently, labor and time of the casher for asking the customer which of the normal receipt and the saving receipt the customer desires is saved, it is possible to realize an increase in speed of the checkout processing.

The commodity sales data processing apparatus 1 may cause the casher side display 5 to display, together with a message for asking the customer which of the normal mode and the saving mode the customer desires, the operation key equivalent to the printing mode selection key 34 at predetermined timing during the checkout processing and may switch the normal mode and the saving mode according to touch operation of the operation key via the touch panel 6. Consequently, since even a casher unaccustomed to the operation of the commodity sales data processing apparatus 1 can easily make the fullest use of the various functions related to receipt issuance, it is possible to smoothly proceed with the checkout processing.

In the explanation in the embodiment, a receipt is printed in the normal mode as long as the printing mode selection key 34 is not operated. However, the saving mode may be set as default setting and a receipt may be printed in the saving mode as long as the normal mode is not selected by the casher or the customer.

A flag for designating one of the normal mode and the saving mode may be formed in the HDD 33 or the like and a receipt may be printed in the normal mode or the saving mode according to designation by the flag. In this case, for example, when the key switch 3 is operated and the operation mode shifts to a maintenance mode, the designation of the mode by the flag can be changed.

In the explanation in the embodiment, the logo of the store included in the printing data of the receipt is deleted, the font of the commodity data is reduced, and the printing data is corrected such that the reduced commodity data is arranged in two rows along the conveying direction of the receipt sheet. However, line spacing between character strings included in the printing data may be narrowed or the commodity data may be arranged in more than two rows along the conveying direction to reduce the length of the receipt.

In the explanation in the embodiment, the monetary unit is Japanese Yen. However, the monetary unit may also be other such as US dollar.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing apparatus comprising:
a printing unit configured to print a receipt;
an input unit configured to receive input of information concerning a commodity;
a printing-data creating unit configured to create, on the basis of information concerning commodities input via the input unit in one commercial transaction, printing data for causing the printing unit to print a receipt including detail information of the transaction;
a correcting unit configured to correct the printing data such that length of the receipt printed by the printing unit on the basis of the printing data is reduced; and
a printing control unit configured to cause the printing unit to print a receipt based on one of the printing data created by the printing-data creating unit and the printing data corrected by the correcting unit.

2. The apparatus according to claim 1, further comprising a selection receiving unit configured to receive selection concerning which of the printing data created by the printing-data creating unit and the printing data corrected by the correcting unit is used to print the receipt, wherein
the printing control unit causes, according to the selection received by the selecting unit, the printing unit to print a receipt based on one of the printing data created by the printing-data creating unit and the printing data corrected by the correcting unit.

3. The apparatus according to claim 2, wherein the selection receiving unit receives, for each commercial transaction, selection concerning which of the printed data created by the printing-data creating unit and the printing data corrected by the correcting unit is used to print the receipt.

4. The apparatus according to claim 1, wherein
the printing-data creating unit creates printing data including a first area representing information concerning a store where a commercial transaction is performed, a second area representing information concerning respective commodities input via the input unit in one commercial transaction, and a third area representing at least a total price of the transaction, and
the correcting unit corrects the printing data such that receipt length in the third area is not changed and receipt length in the first area and the second area is reduced.

5. The apparatus according to claim 1, wherein
the printing-data creating unit creates printing data of a receipt including a logo of a store where a commercial transaction is performed, and
the correcting unit deletes the logo from the printed data created by the printing-data creating unit.

6. The apparatus according to claim 1, wherein
the printing-data creating unit creates printing data of a receipt including a logo of a store where a commercial transaction is performed, and
the correcting unit replaces the logo of the printed data created by the printing-data creating unit with a character string indicating store information.

7. The apparatus according to claim 1, wherein
the printing-data creating unit creates printing data of a receipt in which information concerning respective commodities input via the input unit in one commercial transaction is arranged, and
the correcting unit reduces a font of the information concerning the commodities of the printing data created by the printing-data creating unit.

8. The apparatus according to claim 1, wherein
the printing-data creating unit creates printing data in which various kinds of information are arranged in one row, and
the correcting unit arranges, in plural rows, the information concerning the printing data created by the printing-data creating unit.

9. The apparatus according to claim 1, wherein
the printing-data creating unit creates printing data in which information concerning respective commodities input via the input unit in one commercial transaction is arranged in one row in a width direction of the receipt, and
the correcting unit arranges, in plural rows in the width direction, the information concerning the commodities of the printing data created by the printing-data creating unit.

10. A control method for a commodity sales data processing apparatus including a printing unit configured to print a receipt and an input unit configured to receive input of information concerning a commodity, the control method comprising:
creating, on the basis of information concerning commodities input via the input unit in one commercial transaction, printing data for causing the printing unit to print a receipt including detail information of the transaction;
correcting the printing data such that length of the receipt printed by the printing unit on the basis of the printing data is reduced; and
causing the printing unit to print a receipt based on one of the printing data before the correction and the printing data after the correction.
